(19) United States
(12) Patent Application Publication
(10) Pub. No.: US 2011/0030514 A1
(43) Pub. Date: Feb. 10, 2011

(54) Ratchet wrench assembly

(76) Inventor: Jung-Chi Chiang, Wurih Township (TW)

Correspondence Address: BACON & THOMAS, PLLC, 625 SLATERS LANE, FOURTH FLOOR, ALEXANDRIA, VA, 22314-1176, US

(21) Appl. No.: 12/461,218

(22) Filed: Aug. 5, 2009

(51) Int. Cl. B25B 13/46

(52) U.S. Cl. 81/60

(57) ABSTRACT

A ratchet wrench assembly has a handle bar, a ratchet head and a connecting rod. The handle bar has a grip and a U-shaped ratchet mount. The U-shaped ratchet mount has two connecting holes. The connecting holes are respectively defined through the U-shaped ratchet mount and align with each other. The ratchet head is detachably mounted on the U-shaped ratchet mount and has a hollow housing, two connecting openings, a ratchet device and a pressing body. The connecting openings are respectively defined through the housing and respectively align with the connecting holes. The ratchet device is mounted in the housing. The pressing body is rotatably mounted through the ratchet device and has a through opening radially defined through the pressing body. The connecting rod is mounted through the connecting holes, the connecting openings and the through opening.

### BACKGROUND OF THE INVENTION

1. Field of the Invention

The present invention relates to a handheld wrench apparatus, and more particularly to a ratchet wrench assembly.

2. Description of Related Art

With reference to FIG. 6, a conventional ratchet wrench assembly comprises a handle bar (70), a ratchet head (80) and two bolts (90). The handle bar (70) has a grip (71), a ratchet mount (72) and two connecting holes (73). The grip (71) has two ends. The ratchet mount (72) is semi-circular in shape, is mounted securely on one end of the grip (71) and has two ends. The connecting holes (73) are respectively defined through the ends of the ratchet mount (72) and align with each other. The ratchet head (80) is detachably mounted on the handle bar (70) between the ends of the ratchet mount (72) and has a main body (81) and a ratchet device (82). The main body (81) is round and has an outer surface and two threaded holes (811). The threaded holes (811) are defined in the outer surface of the main body (81) and respectively align with the connecting holes (73). The ratchet device (82) is mounted in the body (81). The bolts (90) are respectively mounted though the connecting holes (73) and are respectively screwed with the threaded holes (811) to securely mount the ratchet head (80) on the handle bar (70). However, the conventional ratchet wrench assembly has some drawbacks.

1. Easily Damaged

The bolts (90) bears most of the load during the operation of the conventional ratchet wrench assembly so the bolts (90), connecting holes (73) and threaded holes (811) are easily damaged and worn off and a useful life of the bolts (90) is reduced. Moreover, the bolts (90) are two individual components so a structural strength of the bolts (90) is not sufficient for large loads.

2. Easily Worn

Because the bolts (90) and the threaded holes (811) bear most of the load and contact each other directly, the threaded holes (811) are easily rubbed by the bolts (90) and worn off and gradually enlarged. The worn and enlarged threaded holes (811) reduce efficiency of operation and a useful life of the conventional ratchet wrench assembly.

3. Weak Structural Strength

A structural strength of the ratchet mount (72) is not sufficient to bear a heavy load and the ratchet mount (72) is easily deformed. However, the grip (71) is solid and heavy, so the conventional ratchet wrench assembly is not easily portable and has a high manufacture cost.

4. Inconvenient Use in a Narrow Space

The size of the main body (81) of the ratchet head (80) has to be large enough to contain the ratchet device (82) inside, so the volume of the ratchet mount (72) correspondingly becomes large so prevents the ratchet mount (72) from being used in small or awkward access places.

To overcome the shortcomings, the present invention tends to provide a ratchet wrench assembly to mitigate and obviate the aforementioned problems.

### SUMMARY OF THE INVENTION

The main objective of the invention is to provide a ratchet wrench assembly which comprises a handle bar, a ratchet head and a connecting rod. The connecting rod is a single component, has a stronger structure and is not easily damaged.

The second objective is to cushion the load applied to the connecting rod and the connecting openings and to keep the connecting rod from directly contacting and rubbing the ratchet head so a useful life of the ratchet head will be increased.

The third objective is to provide an enhanced structural strength of the handle bar.

The forth objective is to allow the ratchet wrench assembly to be operated in small or awkward places more conveniently.

A ratchet wrench assembly has a handle bar, a ratchet head and a connecting rod. The handle bar has a grip and a U-shaped ratchet mount. The U-shaped ratchet mount has two connecting holes. The connecting holes are respectively defined through the U-shaped ratchet mount and align with each other. The ratchet head is detachably mounted on the U-shaped ratchet mount and has a hollow housing, two connecting openings, a ratchet device and a pressing body. The connecting openings are respectively defined through the housing and respectively align with the connecting holes. The ratchet device is mounted in the housing. The pressing body is rotatably mounted through the ratchet device and has a through opening radially defined through the pressing body. The connecting rod is mounted through the connecting holes, the connecting openings and the through opening.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a ratchet wrench assembly in accordance with the present invention;

FIG. 2 is an enlarged exploded perspective view of the ratchet wrench assembly in FIG. 1;

FIG. 3 is an enlarged side view in partial section of the ratchet wrench assembly in FIG. 1;

FIG. 4 is an enlarged end view in partial section of the ratchet wrench assembly in FIG. 1;

FIG. 5 is an enlarged end view in partial section of the ratchet wrench assembly along line 5-5 in FIG. 3; and

FIG. 6 is a partially exploded perspective view of a conventional ratchet wrench assembly in accordance with the prior art.

### DETAILED DESCRIPTION OF PREFERRED EMBODIMENT

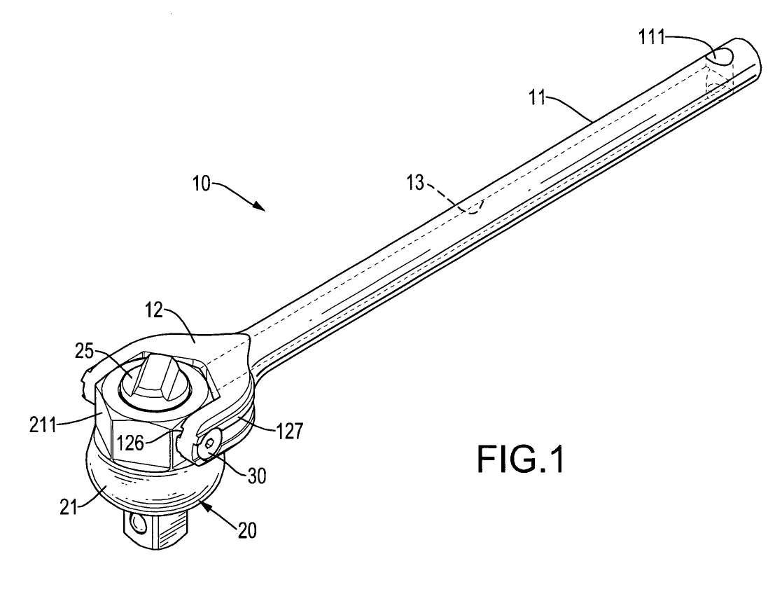

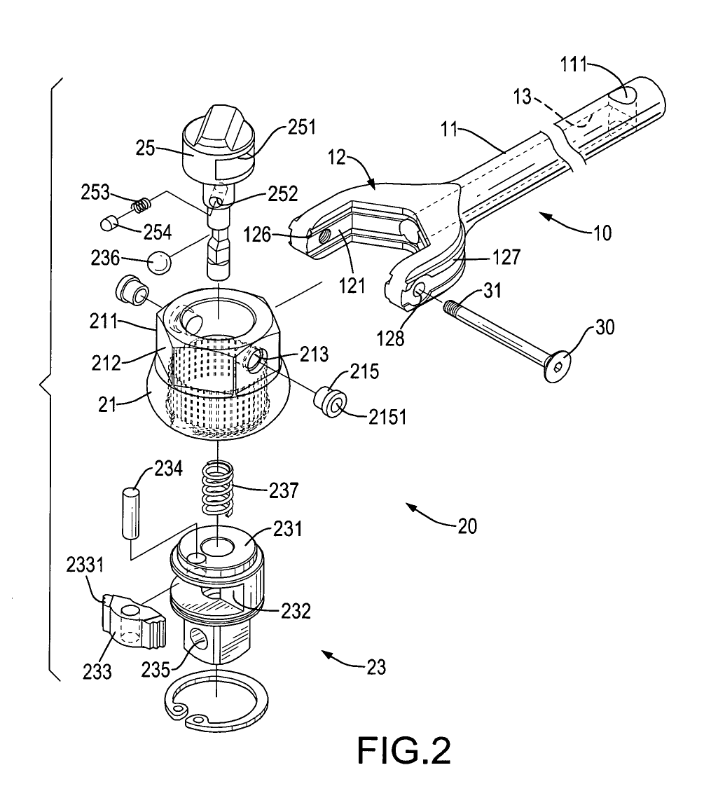

With reference to FIGS. 1 and 2, a ratchet wrench assembly in accordance with the present invention comprises a handle bar (10), a ratchet head (20) and a connecting rod (30).

The handle bar (10) has a grip (11), a U-shaped ratchet mount (12) and an aperture (13). The grip (11) is a hollow rod and has a first end, a second end, an outer surface and a handle hole (111). The handle hole (111) is radially defined through the outer surface near the first end of the grip (11). The U-shaped ratchet mount (12) is mounted securely on the second end of the grip (11) and has two ends, an inner side, an outer side, two planes (121), at least one groove (126), at least one rib (127) and two connecting holes (128). The planes (121) are flat, are formed on the inner side respectively near the ends of the U-shaped ratchet mount (12) and are parallel to each other. The outer side of the U-shaped ratchet mount (12) has a central part. The central part of the outer side of the U-shaped mount (12) is securely attached to the second end of the grip (11). The at least one groove (126) is recessed in the inner side of the U-shaped ratchet mount (12) from one plane (121) to the other. The at least one rib (127) is formed on the outer side of the U-shaped ratchet mount (12) and respectively corresponds to and aligns with the at least one groove (126). Preferably, two grooves (126) and two ribs (127) are implemented. The connecting holes (128) are respectively defined through the planes (121) and align with each other. One of the connecting holes (128) is threaded, and the other is a through hole. The aperture (13) is defined axially through the U-shaped ratchet mount (12) and the grip (11), is defined through the inner side and the outer side of the U-shaped ratchet mount (12) and communicates with the handle hole (111).

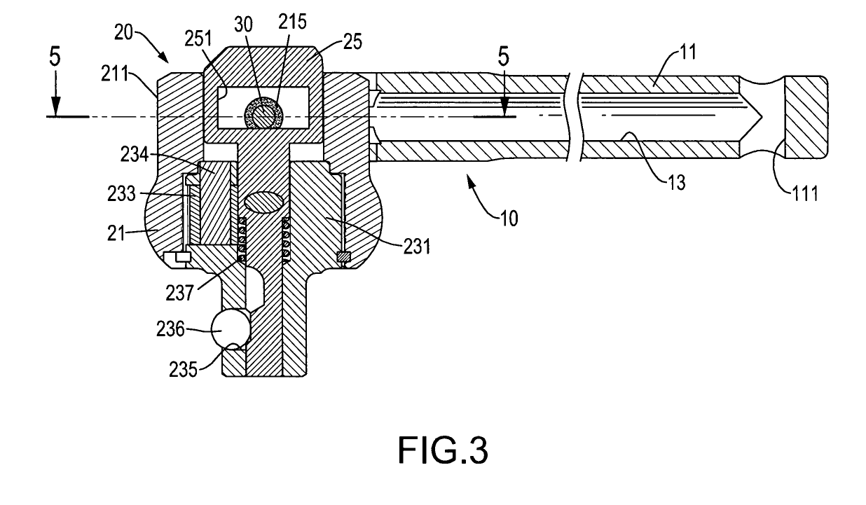

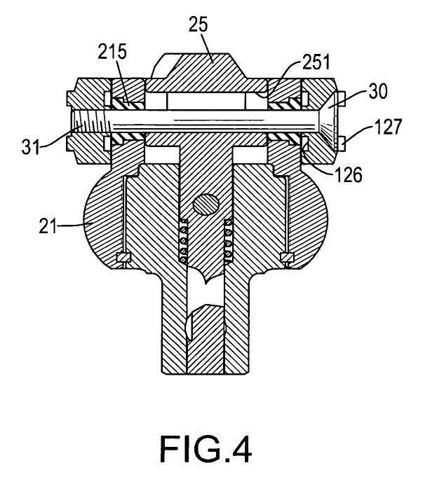

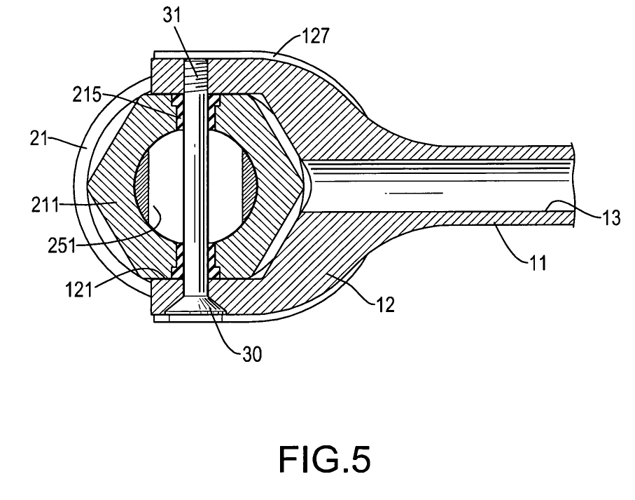

With further reference to FIGS. 3 to 5, the ratchet head (20) is detachably mounted on the handle bar (10), between the planes (121) of the U-shaped ratchet mount (12) and has a housing (21), a ratchet device (23) and a pressing body (25). The housing (21) is hollow and cylindrical, is mounted between the planes (121) and has a top end, an inside space, a maximum diameter, an extending section (211), two flanks (212), two connecting openings (213) and two cushions (215). The extending section (211) is defined on the top end of the housing (21) and has an outer surface, an inner surface and a maximum diameter. The inner surface of the extending section (211) is round. The maximum diameter of the extending section (211) is smaller than that of the housing (21). Preferably, the extending section (211) is hexagonal. The flanks (212) are defined around the outer surface of the extending section (211), are flat and respectively abut the planes (121) of the U-shaped ratchet mount (12). The connecting openings (213) are respectively defined through the flanks (212), communicate with the inside space of the housing (21) and respectively align with the connecting holes (128). The cushions (215) are respectively mounted securely in the connecting openings (213), are made of elastic rubber and each has a cushion hole (2151). The cushions holes (2151) are respectively defined axially through the cushions (215) and respectively align with the connecting holes (128). The ratchet device (23) is mounted in the inside space of the housing (21) and has a rotation body (231), a block opening (232), a block (233), a pin (234), a ball hole (235), a steel ball (236) and a first spring (237). The rotation body (231) has an outer surface. The block opening (232) is recessed in the outer surface of the rotation body (231). The block (233) is mounted in the block opening (232) and has two pawl sides (2331). The pin (234) is mounted through the rotation body (231) and the block (233). The ball hole (235) is recessed in the outer surface of the rotation body (231). The steel ball (236) is mounted in the ball hole (235). The first spring (237) is mounted through the rotation body (231). The structure of the ratchet device (23) may be conventional so detailed description of the ratchet device (23) is omitted. The pressing body (25) is rotatably mounted through the ratchet device (23) in a rotation range and has a top end, a through opening (251), a knob hole (252), a second spring (253) and a knob (254). The top end of the pressing body (25) corresponds to and abuts the inner surface of the extending section (211). The through opening (251) is radially defined through the top end of the pressing body (25), is rectangular in cross section and communicates with the connecting openings (213) and has a width and a height. The knob hole (252) is recessed radially in the pressing body (25). The second spring (253) is mounted in the knob hole (252). The knob (254) is mounted in the knob hole (252) between the second spring (253) and the block (233). The structure of the knob hole (252), the second spring (253) and the knob (254) may be conventional and detailed description is omitted. The relationship between the pressing body (25) and the ratchet device (23) may also be conventional and detailed description is omitted.

The connecting rod (30) is mounted through the connecting holes (128), the cushion holes (2151) and the through opening (251) and has a diameter and a threaded end (31). The diameter of the connecting rod (30) is smaller than the width and the height of the through opening (251), as shown in FIG. 3 to allow the pressing body (25) to rotate and move up and down in a small range. The threaded end (31) is screwed with the threaded connecting hole (128).

From the above description, it is noted that the invention has the following advantages:

1. Enhanced Structural Strength of the Connecting Rod (30)

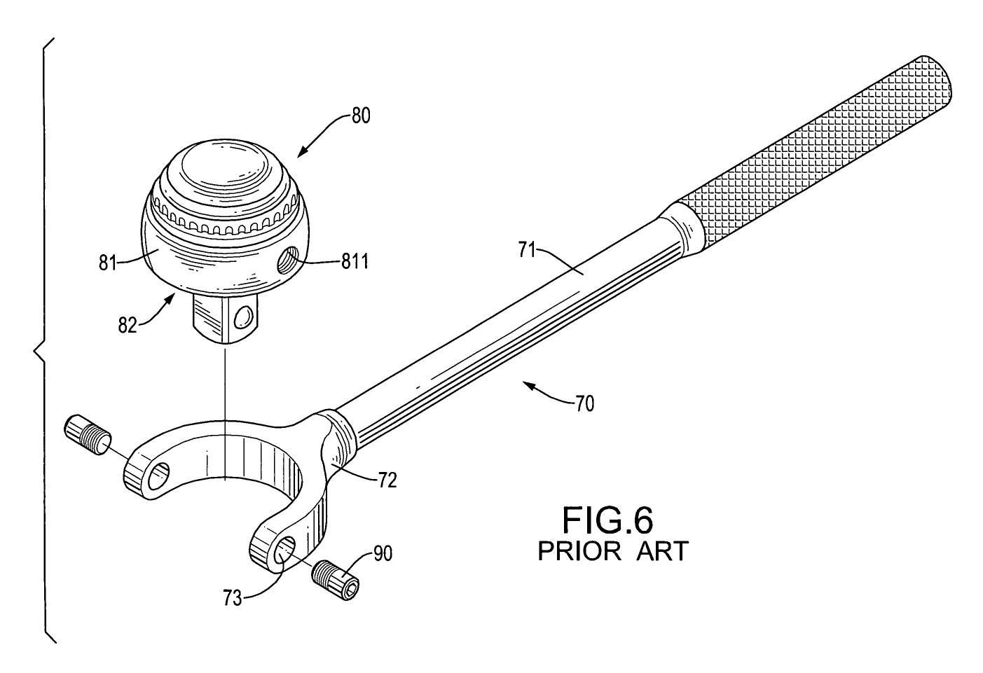

The connecting rod (30) is a single component and a structural strength of the connecting rod (30) is stronger than that of two individual bolts (90) as shown in FIG. 6. Therefore, the connecting rod (30) is not easily damaged.

2. Larger Contact Area

The abutment of the planes (121) and the flanks (212) can increase the contact area between the U-shaped ratchet mount (12) and the ratchet head (20). This can share and reduce force and load applied to the connecting rod (30).

3. Cushion the Load

The cushions (215) can cushion the load applied to the connecting rod (30) and the connecting openings (213), and prevent the connecting rod (30) from directly contacting the ratchet head (20). Therefore, the connecting openings (213) are not easily worn off or gradually enlarged so a useful life of the ratchet head (20) will be prolonged.

4. Improved Structure of the Handle Bar (10)

The structural strength of the U-shaped ratchet mount (12) can be strengthened with the ribs (127) and the grooves (126), so the U-shaped ratchet mount (12) is not easily deformed. With the hollow grip (11), the weight of the handle bar (10) can be efficiently reduced to make the ratchet wrench assembly easily portable and to reduce the cost for manufacturing the ratchet wrench assembly.

5. Convenient Use in a Narrow Space:

Because the extending section (211) is a narrower section of the housing (21), the U-shaped ratchet mount (12) can correspondingly become smaller. The reduced volume of the U-shaped ratchet mount (12) is easily put in a narrow or awkward access places.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ratchet wrench assembly comprising:
a handle bar having
a grip having a first end and a second end; and
a U-shaped ratchet mount mounted securely on the second end of the grip and having
two ends;
an inner side;
an outer side;
two connecting holes respectively defined through the ends of the U-shaped ratchet mount and aligning with each other;
a ratchet head detachably mounted on the handle bar between the ends of the U-shaped ratchet mount and having
a hollow housing mounted between the ends of the U-shaped ratchet mount and having
a top end;
an inside space;
an extending section defined on the top end of the housing; and
two connecting openings respectively defined through the extending section, communicating with the inside space of the housing and respectively aligning with the connecting holes;
a ratchet device mounted in the inside space of the housing; and
a pressing body rotatably mounted through the ratchet device and having
a top end; and
a through opening radially defined through the top end of the pressing body and communicating with the connecting openings; and
a connecting rod mounted through the connecting holes, the connecting openings and the through opening.

2. The ratchet wrench assembly as claimed in claim 1, wherein
the U-shaped ratchet mount has
two flat planes formed on the inner side respectively near the ends of the U-shaped ratchet mount and parallel to each other;
the extending section has an outer surface; and
the housing has
two flat flanks defined on the outer surface of the extending section and respectively abutting the planes of the U-shaped ratchet mount.

3. The ratchet wrench assembly as claimed in claim 1, wherein
the housing has
two cushions respectively mounted securely in the connecting openings, made of elastic rubber and having
two cushion holes respectively defined axially through the cushions and respectively aligning with the connecting holes; and
the connecting rod is mounted through the connecting holes, the cushion holes and the through opening.

4. The ratchet wrench assembly as claimed in claim 2, wherein
the housing has
two cushions respectively mounted securely in the connecting openings, made of elastic rubber and having
two cushion holes respectively defined axially through the cushions and respectively aligning with the connecting holes; and
the connecting rod is mounted through the connecting holes, the cushion holes and the through opening.

5. The ratchet wrench assembly as claimed in claim 1, wherein
the U-shaped ratchet mount has
at least one groove recessed in the inner side of the U-shaped ratchet mount from one of the planes to the other; and
at least one rib formed on the outer side of the U-shaped ratchet mount and respectively corresponding to and aligning with the at least one groove.

6. The ratchet wrench assembly as claimed in claim 2, wherein
the U-shaped ratchet mount has
at least one groove recessed in the inner side of the U-shaped ratchet mount from one of the planes to the other; and
at least one rib formed on the outer side of the U-shaped ratchet mount and respectively corresponding to and aligning with the at least one groove.

7. The ratchet wrench assembly as claimed in claim 3, wherein
the U-shaped ratchet mount has
at least one groove recessed in the inner side of the U-shaped ratchet mount from one of the planes to the other; and
at least one rib formed on the outer side of the U-shaped ratchet mount and respectively corresponding to and aligning with the at least one groove.

8. The ratchet wrench assembly as claimed in claim 4, wherein
the U-shaped ratchet mount has
at least one groove recessed in the inner side of the U-shaped ratchet mount from one the planes to the other; and
at least one rib formed on the outer side of the U-shaped ratchet mount and respectively corresponding to and aligning with the at least one groove.

9. The ratchet wrench assembly as claimed in claim 1, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

10. The ratchet wrench assembly as claimed in claim 2, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

11. The ratchet wrench assembly as claimed in claim 3, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

12. The ratchet wrench assembly as claimed in claim 4, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

13. The ratchet wrench assembly as claimed in claim 5, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

14. The ratchet wrench assembly as claimed in claim 6, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

15. The ratchet wrench assembly as claimed in claim 7, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

16. The ratchet wrench assembly as claimed in claim 8, wherein
the outer side of the U-shaped ratchet mount has
a central part securely attached to the second end of the grip; and
the handle bar has
an aperture defined axially through the U-shaped ratchet mount and the grip, and defined through the inner side and the outer side of the U-shaped ratchet mount.

17. The ratchet wrench assembly as claimed in claim 1, wherein
the housing has a maximum diameter; and
the extending section has a maximum diameter which is smaller than that of the housing.

18. The ratchet wrench assembly as claimed in claim 2, wherein
the housing has a maximum diameter; and
the extending section has a maximum diameter which is smaller than that of the housing.

19. The ratchet wrench assembly as claimed in claim 3, wherein
the housing has a maximum diameter; and
the extending section has a maximum diameter which is smaller than that of the housing.

20. The ratchet wrench assembly as claimed in claim 4, wherein
the housing has a maximum diameter; and
the extending section has a maximum diameter which is smaller than that of the housing.
